(19) United States
(12) Patent Application Publication
(10) Pub. No.: US 2014/0072159 A1
(43) Pub. Date: Mar. 13, 2014

(54) LEAK TOLERANT ACOUSTIC TRANSDUCER FOR MOBILE DEVICE

(71) Applicants: Carey Moulton, Miami, FL (US); Mikhail Bruk, Hicksville, NY (US)

(72) Inventors: Carey Moulton, Miami, FL (US); Mikhail Bruk, Hicksville, NY (US)

(73) Assignee: Motorola Solutions, Inc., Schaumburg, IL (US)

(21) Appl. No.: 13/609,514

(22) Filed: Sep. 11, 2012

(51) Int. Cl. H04R 1/02

(52) U.S. Cl. 381/334

(57) ABSTRACT

A mobile device is described. The mobile device includes an acoustic transducer that projects sound in a first direction and a second direction. A housing includes a cavity. The acoustic transducer is positioned in the housing to project sound in the first direction through an aperture in the housing. The transducer also projects sound in the second direction within the cavity. A first port is acoustically coupled to the cavity and acoustically isolated from the aperture. The sound projected in the second direction is emitted through the first port. A membrane covers the aperture and the first port. The membrane receives sound from the aperture and the first port and radiates the sound away from the housing.

### TECHNICAL FIELD

The present disclosure relates generally to acoustic transducers for mobile devices.

### BACKGROUND

Mobile devices including cellular telephones generally use a receiver which is held close to the user's ear for privacy during operation. The receiver includes a small audio transducer to reproduce sound from received audio signals. The small size of these audio transducers generally limits the loudness and/or the audio quality of the sound generated by them. The loudness and the audio quality is further limited if a water resistant shield is placed over the audio transducer.

### SUMMARY

In one aspect, the invention is embodied in a mobile device. The mobile device includes an acoustic transducer that projects sound in a first direction and a second direction. A housing includes a cavity. The acoustic transducer is positioned in the housing to project sound in the first direction through an aperture in the housing. The transducer also projects sound in the second direction within the cavity. A first port is acoustically coupled to the cavity and acoustically isolated from the aperture. The sound projected in the second direction is emitted through the first port. A membrane covers the aperture and the first port. The membrane receives sound from the aperture and the first port and radiates the sound away from the housing.

In one embodiment, the membrane prevents liquid from entering the aperture and the first port. The sound emanating from the membrane covering the aperture can be emitted into an opening in an ear of a user. The sound emanating from the membrane covering the first port stimulates a tympanic membrane located behind an earlobe of an ear of a user.

In one embodiment, the mobile device can include a second port acoustically coupled to the cavity and acoustically isolated from the aperture. The aperture can be located between the first port and the second port. The membrane can also cover the second port. In one embodiment, the sound emanating from the membrane covering the first port is out of phase with the sound emanating from the membrane covering the aperture. The membrane can be fabricated from a silicon, plastic, polypropylene, rubber or aluminum material.

In another aspect, the invention is embodied in a method for radiating sound from a mobile device. The method includes projecting sound in a first direction through an aperture in a housing of a mobile device. The method further includes projecting sound in a second direction into a cavity of the housing. The sound projected in the second direction is emitted through a first port acoustically coupled to the cavity and acoustically isolated from the aperture. The aperture and the first port are covered with a membrane. The membrane receives sound from the aperture and the first port and radiates the sound away from the housing.

In one embodiment, the membrane prevents liquid from entering the aperture and the first port. The sound emanating from the membrane covering the aperture can be emitted into an opening in an ear of a user. The sound emanating from the membrane covering the first port can stimulate a tympanic membrane located behind an earlobe of an ear of a user.

The method can also include acoustically coupling a second port to the cavity and acoustically isolating the second port from the aperture. The aperture can be positioned between the first port and the second port. The second port can be covered with the membrane. The membrane can prevent liquid from entering the second port. In one embodiment, the sound emanating from the membrane covering the first port is out of phase with the sound emanating from the membrane covering the aperture.

### BRIEF DESCRIPTION OF THE FIGURES

Skilled artisans will appreciate that elements in the figures are illustrated for simplicity and clarity and have not necessarily been drawn to scale. For example, the dimensions of some of the elements in the figures may be exaggerated relative to other elements to help improve understanding of various embodiments. In addition, the description and drawings do not necessarily require the order illustrated. It will be further appreciated that certain actions and/or steps may be described or depicted in a particular order of occurrence while those skilled in the art will understand that such specificity with respect to sequence is not actually required. Apparatus and method components have been represented where appropriate by conventional symbols in the drawings, showing only those specific details that are pertinent to understanding the various embodiments so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

The above and further advantages of this invention may be better understood by referring to the following description in conjunction with the accompanying drawings, in which like numerals indicate like structural elements and features in various figures. Skilled artisans will appreciate that reference designators shown herein in parenthesis indicate components shown in a figure other than the one in discussion. For example, talking about a device (10) while discussing Figure A would refer to an element, 10, shown in figure other than Figure A.

FIG. 1 illustrates a mobile device according to one embodiment of the invention.

FIG. 2 is a block diagram of the components of a mobile device according to one embodiment of the present invention.

FIG. 3 illustrates an exemplary audio transducer assembly according to the invention.

FIG. 4 illustrates a leak tolerant membrane according to one embodiment of the present invention.

FIG. 5 illustrates a method for generating sound from a mobile device according to one embodiment of the invention.

### DETAILED DESCRIPTION

The following detailed description is merely illustrative in nature and is not intended to limit the invention or the application and uses of the invention. Furthermore, there is no intention to be bound by any express or implied theory presented in the preceding technical field, background, brief summary or the following detailed description. For the purposes of conciseness, many conventional techniques and principles related to fabricating and using conventional mobile devices, need not, and are not, described in detail herein.

Techniques and technologies may be described herein in terms of functional and/or logical block components and various processing steps. It should be appreciated that such block components may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

The following description may refer to elements or nodes or features being “connected” or “coupled” together. As used herein, unless expressly stated otherwise, “connected” means that one element/node/feature is directly joined to (or directly communicates with) another element/node/feature, and not necessarily mechanically. Likewise, unless expressly stated otherwise, “coupled” means that one element/node/feature is directly or indirectly joined to (or directly or indirectly communicates with) another element/node/feature, and not necessarily mechanically. The term “exemplary” is used in the sense of “example, instance, or illustration” rather than “model,” or “deserving imitation.”

Technologies and concepts discussed herein relate to an acoustic transducer for a mobile device. The mobile device includes an acoustic transducer that projects sound in a first direction and a second direction. The mobile device can include a housing having a cavity. The acoustic transducer is positioned in the housing to project sound in the first direction through an aperture in the housing and to project sound in the second direction within the cavity. A first port is acoustically coupled to the cavity and acoustically isolated from the aperture. The sound projected in the second direction is emitted through the first port. A membrane covers the aperture and the first port. The membrane receives sound from the aperture and the first port and radiates the sound away from the housing.

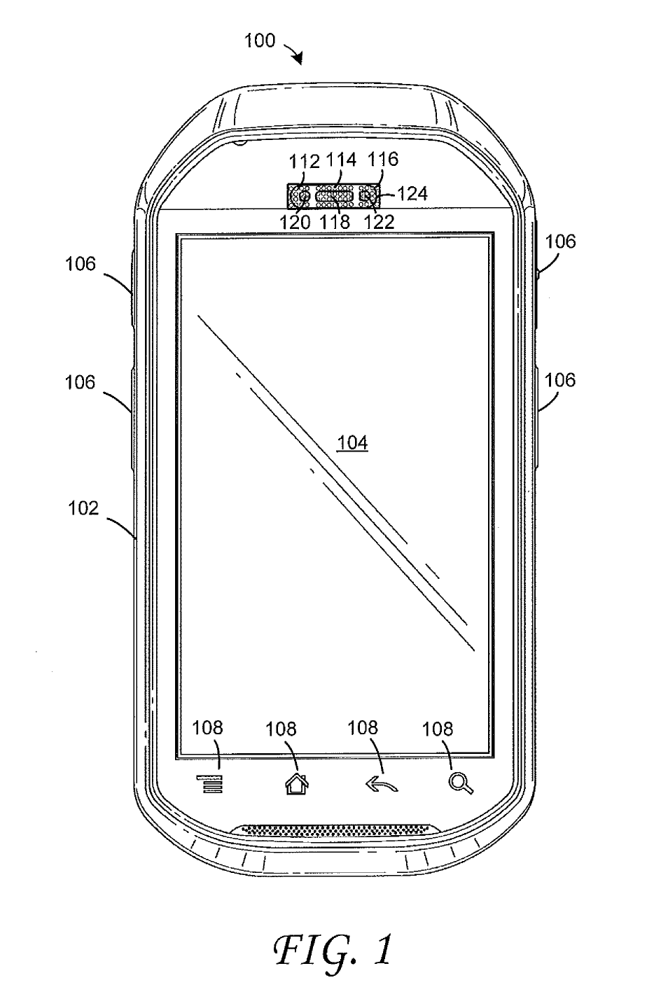

FIG. 1 illustrates a mobile device 100 according to one embodiment of the invention. The mobile device includes a housing 102. A display 104 is supported by the housing. The display 104 can be a liquid crystal display (LCD) including touch screen capability.

The housing 102 can include one or more control switches 106 for controlling different functions of the mobile device 100. The display 104 can include one or more soft keys 108. The soft keys 108 can be programmed to activate different functions of the mobile device 100.

The mobile device 100 can also include a screen 110 covering a microphone (not shown). The microphone is configured to receive acoustic signals and convert the acoustic signals to electrical signals.

The mobile device 100 can also include screens 112, 114, 116 covering an audio transducer (not shown). The audio transducer is configured to transmit acoustic signals through a center acoustic aperture 118 and first 120 and optional second acoustic ports 122. The screen 114 covers the center acoustic aperture 118. The screens 112, 114, 116 also cover a membrane 124. The membrane 124 prevents liquid from entering the center acoustic aperture 118 and the first 120 and second acoustic ports 122.

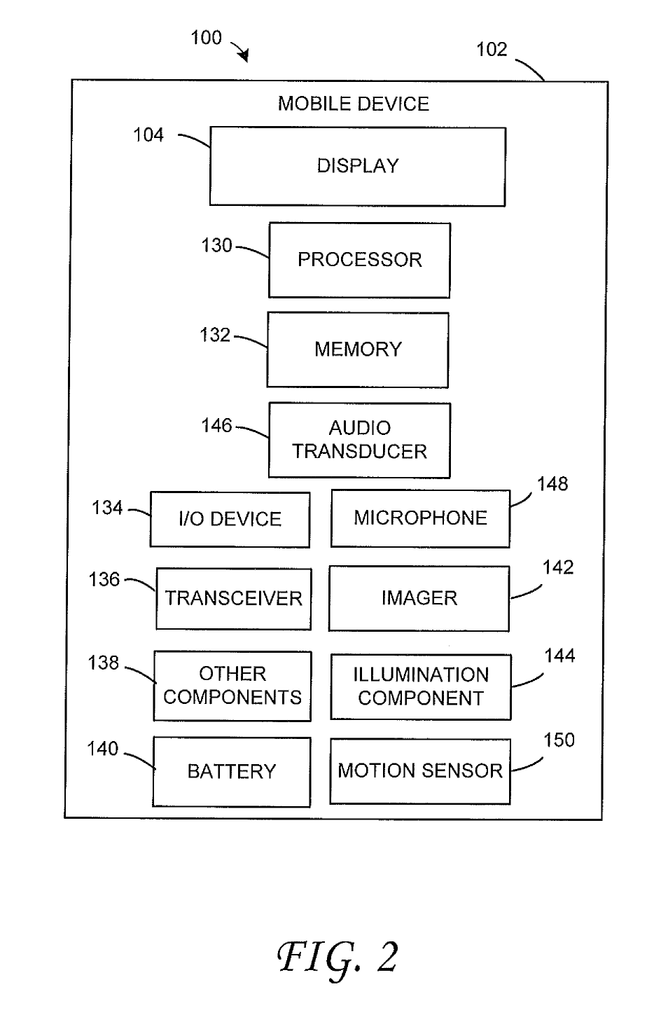

FIG. 2 is a block diagram of the components of the mobile device 100 according to one embodiment of the present invention. The mobile device 100 can be any portable device such as a mobile computer, a mobile phone, a personal digital assistant, a Smartphone, etc. As illustrated in FIG. 2, the mobile device 100 can include a processor 130, a memory 132, the display 104, input/output (I/O) device 134, a transceiver 136, other components 138, a battery 140, an imager 142, an illumination component 144, an audio transducer 146, a microphone 148, and a motion sensor 150, such as an accelerometer.

The processor 130 can provide conventional functionalities for the mobile device 100. In a specific example according to the exemplary embodiments of the present invention and as will be described in further detail below, the mobile device 100 can include a plurality of software applications that are executed on the processor 130 such as a software application related to processing audio signals. The memory 132 can also provide conventional functionalities for the mobile device 100. For example, the memory 132 can store data and software applications related to operations performed by the processor 130.

The audio transducer 146 is configured to reproduce sound in response to audio signals received from the processor 130. In one embodiment, the processor 130 can include an audio codec. The microphone 148 is configured to receive sound and convert the sound into electrical signals.

The display 104 can be any component configured to display data to a user. The display 104 can include, for example, a liquid crystal display (LCD) at least partially disposed within the housing 102 of the mobile device 100. The I/O device 134 can be any component configured to receive an input from the user, such as the control switch 106 and the soft keys 108. In one embodiment, the I/O device 134 can be a keypad (e.g., alphanumeric keypad, numeric keypad, etc.). The I/O device 134 can also include a touch sensing pad for a user to enter inputs manually with a finger or a stylus. According to one embodiment, the display 104 can also incorporate the I/O device 134 in a touch screen configuration. For example, the I/O device 134 can be a transparent touch sensor placed over the display 104 that enables a user to enter inputs by touching the touch sensor.

The transceiver 136 can provide the mobile device 100 with a method of exchanging data with a communications network. The other components 138 can include additional components conventionally found in electronic devices, such as charging circuitry and one or more antennas, for example.

The imager 142 can be any component configured to capture image data. For example, the imager 142 can include any type of image sensor or sensors. The imager 142 can capture an image in a field of view (FoV) of the imager 142. In one embodiment, the image captured in the FoV of the imager 142 can be displayed on the display 104.

The mobile device 100 can include an illumination component 144 to illuminate an area including the FoV of the imager 142. The illumination component 144 can improve the performance of the imager 142, particularly when there is insufficient light for a suitable image to be captured.

As previously described, the display 104 can include the I/O device 134 in the form of a touch screen to enable the user to enter inputs directly on the touch screen. The processor 130 can generate a graphical user interface (GUI) on the display 104 to provide icons corresponding to certain functionality.

In operation, a user operating the mobile device 100 can communicate with a user of a remote device, such as a cellular telephone. The user positions the mobile device 100 such that the screens 112, 114, 116 covering the aperture 118 and the ports 120, 122 are placed proximate to an ear of the user and the screen 110 covering the microphone 148 is placed proximate to a mouth of the user.

In one embodiment, the sound emanating from the membrane 124 covering the aperture 118 is emitted into an opening in the ear of the user. The sound emanating from the membrane 124 covering the ports 120, 122 stimulates a tympanic membrane located behind an earlobe of the ear of the user. The sound emanating from the membrane 124 can include low frequency acoustic energy amplified by a cavity in the housing 102 acoustically coupled to the ports 120, 122.

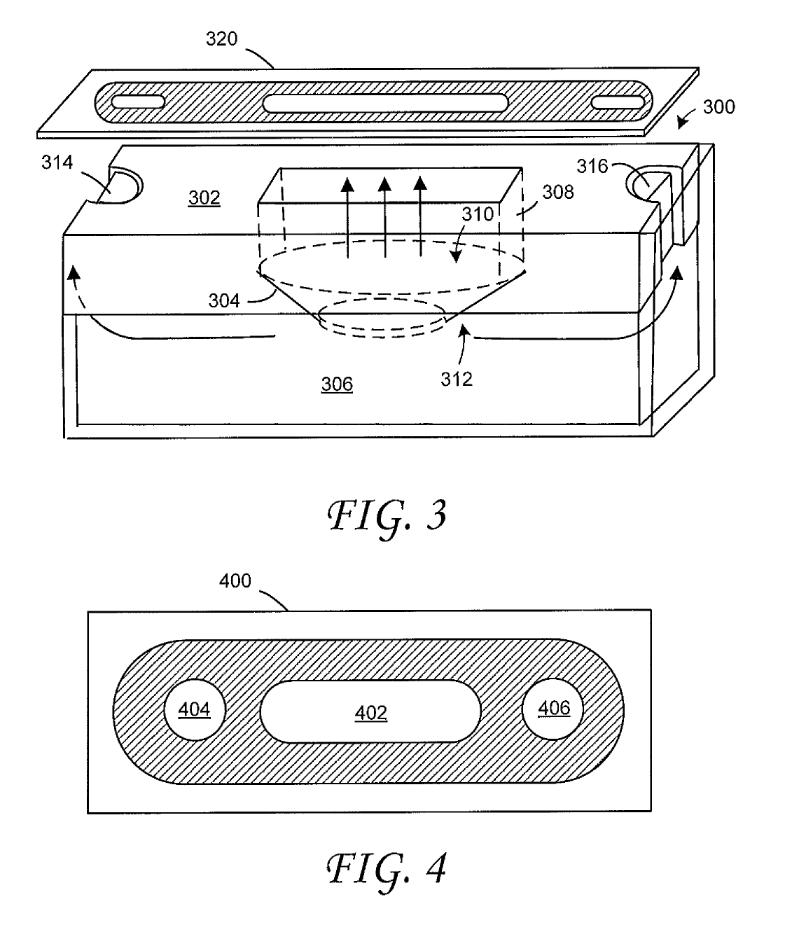

FIG. 3 illustrates an exemplary audio transducer assembly 300 for a mobile device 100 according to the invention. The assembly 300 includes a housing 302 for mounting an audio transducer 304. The audio transducer 304 can be mounted to the housing 302 using any suitable technique. For example, the audio transducer 304 can be mounted using hardware, such as screws or clamps, or adhesive, such as epoxy or cement, for example. The housing 302 is coupled to a cavity 306 in the mobile device 100.

The housing 302 also includes an aperture 308. A first side 310 of the audio transducer 312 is positioned to project sound directly into the aperture 308 in the housing 302. The audio transducer 304 is mounted to the housing 302 such that the first side 310 of the transducer 304 is sealed around the edges of the aperture 308. This seal provides acoustic isolation between the aperture 308 and the cavity 306. Thus, substantially no sound can escape from the aperture 308 into the cavity 306.

A second side 312 of the audio transducer 304 is positioned to project sound away from the aperture 308 and into the cavity 306. The sound projected into the cavity 306 is emitted through the ports 314, 316 in the housing 302. The ports 314, 316 are acoustically coupled to the cavity 306 and are acoustically isolated from the aperture 308. The sound radiating through the ports 314, 316 is out of phase with the sound radiating through the aperture 308. In one embodiment, the aperture 308 is positioned between the first port 314 and the second port 316.

In one embodiment, ports 314, 316 provide an acoustic short circuit for low frequency acoustic energy such that sound emanating from the aperture 308 is combined with sound emanating from the ports 314, 316. Since the ports 314, 316 are proximate to each other, the low frequency response of the audio transducer assembly 300 is the same whether the sound emanating from the assembly 300 is guided leak-free into the opening of an ear of a user or a large acoustic leak exists between the opening of the ear and the assembly 300.

A membrane 320 covers the aperture 308 and the ports 314, 316. In one embodiment, separate membranes cover each of the aperture 308 and the ports 314, 316. The membrane 320 receives sound from the aperture 308 and the ports 314, 316 and radiates the sound away from the housing 302. In one embodiment, the membrane 320 acts as a passive radiator. As previously described, the membrane 320 is configured to prevent liquid from entering the aperture 308 and the ports 314, 316. The membrane 320 can be fabricated from a silicon, plastic, polypropylene, rubber or aluminum material, for example. In practice, any suitable material can be used.

In one embodiment, the sound emanating from the membrane 320 covering the aperture 308 is emitted into an opening in an ear of a user (not shown). The sound emanating from the membrane 320 covering the ports 314, 316 stimulates a tympanic membrane (not shown) located behind an earlobe of an ear of a user.

FIG. 4 illustrates a leak tolerant membrane 400 according to one embodiment of the present invention. The membrane 400 is fabricated from material that substantially prevents liquids from passing through it. The material also radiates acoustic energy.

In one embodiment, the membrane 400 behaves as a passive acoustic radiator when driven by the acoustic transducer 304 (FIG. 3). A passive acoustic radiator does not include a powered (active) transducer. Instead, the passive acoustic radiator receives acoustic energy from another source and vibrates at a frequency corresponding to the active source to radiate the acoustic energy.

The membrane 400 includes a first portion 402 that is shaped to cover the aperture 308 (FIG. 3). The membrane 400 also includes a second portion 404 and a third portion 406 for covering the first 314 and second ports 316. The membrane 400 can be attached to the audio transducer assembly 300 of the mobile device 100 using adhesive, for example.

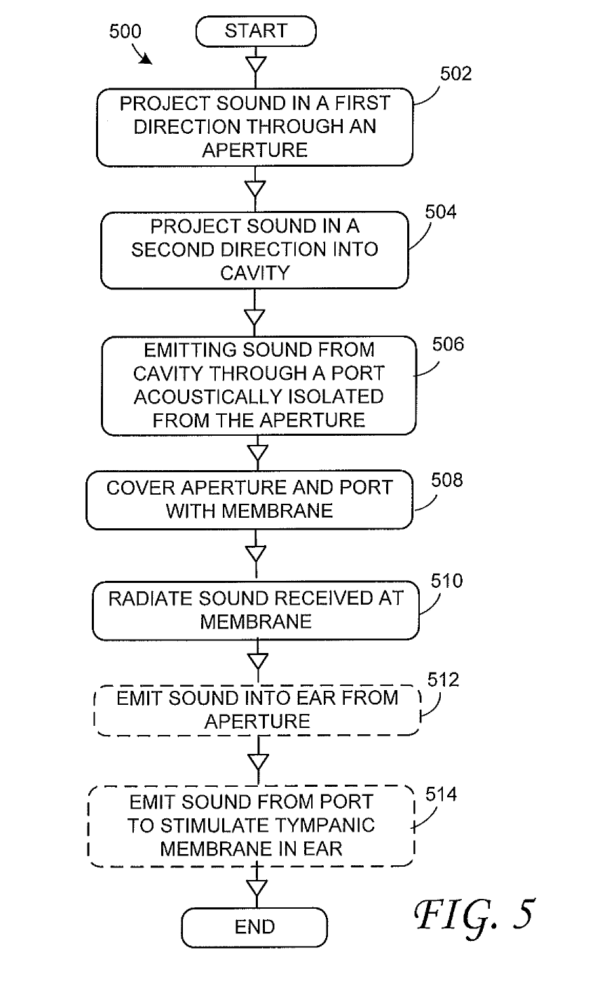

FIG. 5 illustrates a flowchart 500 of a method for generating sound from a mobile device 100 according to one embodiment of the invention. A first side 310 of a transducer 304 (FIG. 3) is positioned in the housing 302 of the mobile device 100 to project sound in a first direction through an aperture 308 in the housing 302 of the mobile device 100 (step 502).

A second side 312 of the transducer 304 projects sound in a second direction into the cavity 306 of the housing 302 (step 504). The sound projected from the second side 312 of the transducer 304 is emitted through a first port 314 acoustically coupled to the cavity 306 and acoustically isolated from the aperture 308 (step 506). In one embodiment, the sound projected from the second side 312 of the transducer 304 is also emitted through a second port 316 that is acoustically coupled to the cavity 306 and acoustically isolated from the aperture 308.

The aperture 308 and the first port 314 are covered with a membrane 320 (step 508). The membrane 320 receives sound from the aperture 308 and the first port 314 and radiates the sound away from the housing 302 (step 510). The membrane 320 can prevent liquid from entering the aperture 308 and the first port 314 to protect the internal circuitry of the mobile device 100 from spilled liquid, for example.

In one embodiment, the sound emanating from the membrane 320 covering the aperture 308 is emitted into an opening of an ear of a user (step 512). The sound emanating from the membrane 320 covering the first port 314 can stimulate a tympanic membrane located behind an earlobe of an ear of a user (step 514).

In one embodiment, the second port 316 is acoustically coupled to the cavity 306 and acoustically isolated from the aperture 308. The aperture 308 can be positioned between the first port 314 and the second port 316. The second port 316 can be covered with the membrane 320. In one embodiment, the sound emanating from the membrane 320 covering the first port 314 is out of phase with the sound emanating from the membrane 320 covering the aperture 308.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the methods and apparatus described herein. The non-processor circuits may include, but are not limited to, a radio receiver, a radio transmitter, signal drivers, clock circuits, power source circuits, and user input devices. As such, these functions may be interpreted as steps of a method described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Both the state machine and ASIC are considered herein as a “processing device” for purposes of the foregoing discussion and claim language.

Moreover, an embodiment can be implemented as a computer-readable storage element or medium having computer readable code stored thereon for programming a computer (e.g., comprising a processing device) to perform a method as described and claimed herein. Examples of such computer-readable storage elements include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

While at least one example embodiment has been presented in the foregoing detailed description, it should be appreciated that a vast number of variations exist. It should also be appreciated that the example embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

In addition, the section headings included herein are intended to facilitate a review but are not intended to limit the scope of the present invention. Accordingly, the specification and drawings are to be regarded in an illustrative manner and are not intended to limit the scope of the appended claims.

In interpreting the appended claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function;

e) any of the disclosed elements may be comprised of hardware portions (e.g., including discrete and integrated electronic circuitry), software portions (e.g., computer programming), and any combination thereof;

f) hardware portions may be comprised of one or both of analog and digital portions;

g) any of the disclosed devices or portions thereof may be combined together or separated into further portions unless specifically stated otherwise; and

h) no specific sequence of acts or steps is intended to be required unless specifically indicated.

What is claimed is:

1. A mobile device comprising:
an acoustic transducer projecting sound in a first direction and a second direction;
a housing comprising a cavity, the acoustic transducer positioned in the housing to project sound in the first direction through an aperture in the housing, and positioned to project sound in the second direction within the cavity;
a first port acoustically coupled to the cavity and acoustically isolated from the aperture, the sound projected in the second direction being emitted through the first port; and
a membrane covering the aperture and the first port, the membrane receiving sound from the aperture and the first port and radiating the sound away from the housing.

2. The mobile device of claim 1, wherein the membrane prevents liquid from entering the aperture and the first port.

3. The mobile device of claim 1, wherein the sound emanating from the membrane covering the aperture is emitted into an opening in an ear of a user.

4. The mobile device of claim 1, wherein the sound emanating from the membrane covering the first port stimulates a tympanic membrane located behind an earlobe of an ear of a user.

5. The mobile device of claim 1, further comprising a second port acoustically coupled to the cavity and acoustically isolated from the aperture, the aperture positioned between the first port and the second port.

6. The mobile device of claim 5, wherein the membrane covers the second port.

7. The mobile device of claim 1, wherein the sound emanating from the membrane covering the first port is out of phase with the sound emanating from the membrane covering the aperture.

8. The mobile device of claim 1, wherein the membrane is fabricated from at least one of a silicon, plastic, polypropylene, rubber and aluminum material.

9. A method comprising:
projecting sound in a first direction through an aperture in a housing of a mobile device;
projecting sound in a second direction into a cavity of the housing;
emitting sound projected in the second direction through a first port acoustically coupled to the cavity and acoustically isolated from the aperture; and
covering the aperture and the first port with a membrane, the membrane receiving sound from the aperture and the first port and radiating the sound away from the housing.

10. The method of claim 9, wherein the membrane prevents liquid from entering the aperture and the first port.

11. The method of claim 9, wherein the sound emanating from the membrane covering the aperture is emitted into an opening in an ear of a user.

12. The method of claim 9, wherein the sound emanating from the membrane covering the first port stimulates a tympanic membrane located behind an earlobe of an ear of a user.

13. The method of claim 9, further comprising acoustically coupling a second port to the cavity and acoustically isolating the second port from the aperture, the aperture positioned between the first port and the second port.

14. The method of claim 13, further comprising covering the second port with the membrane.

15. The method of claim 14, wherein the membrane prevents liquid from entering the second port.

16. The method of claim 9, wherein the sound emanating from the membrane covering the first port is out of phase with the sound emanating from the membrane covering the aperture.

17. A mobile device comprising:
means for projecting sound in a first direction through an aperture in a housing of a mobile device;
means for projecting sound in a second direction into a cavity of the housing;
means for emitting sound projected in the second direction through a first port acoustically coupled to the cavity and acoustically isolated from the aperture; and
means for covering the aperture and the first port with a membrane, the membrane receiving sound from the aperture and the first port and radiating the sound away from the housing.

18. The mobile device of claim 17, further comprising means for acoustically coupling a second port to the cavity and acoustically isolating the second port from the aperture, the aperture positioned between the first port and the second port.

19. The mobile device of claim 18, further comprising means for covering the second port with the membrane.

20. The mobile device of claim 18, wherein the sound emanating from the membrane covering the first port is out of phase with the sound emanating from the membrane covering the aperture.
